(19) United States
(12) Patent Application Publication
(10) Pub. No.: US 2026/0306327 A1
(43) Pub. Date: Oct. 8, 2026

(54) A MOLDABLE PAD ASSEMBLY FOR SUPPORTING A BODY PART

(71) Applicant: Mölnlycke Health Care AB, Mölndal (SE)

(72) Inventors: Patrick Rodzewicz, Göteborg (SE); Conny Jakobsson, Lerum (SE)

(21) Appl. No.: 19/478,495

(22) PCT Filed: Apr. 10, 2024
(86) PCT No.: PCT/EP2024/059680

§ 371 Date: Oct. 24, 2025

(30) Foreign Application Priority Data
May 2, 2023 (EP) 23171030.2

(51) Int. Cl. A61G 7/057

(52) U.S. Cl. CPC A61G 7/05738

(57) ABSTRACT

Described is a moldable pad assembly for supporting a body part; the moldable pad assembly includes a moldable pad, wherein the moldable pad includes an outer shell enclosing a fluidized medium; the outer shell having a top surface facing the body part, and an opposing bottom surface, wherein the moldable pad assembly further includes a cover detachably attached to the outer shell of the moldable pad, wherein the cover is arranged to enclose at least the top surface of the outer shell during use. Also described is a kit that includes a moldable pad.

### TECHNICAL FIELD

The present invention relates to a moldable pad assembly for supporting a body part. The moldable pad comprises an outer shell enclosing a fluidized medium. The present invention also relates to a kit comprising a moldable pad.

### BACKGROUND

Pressure ulcers often arise among persons being bedridden for various reasons, such as for instance due to long term hospitalization or other causes of immobility. When the same location on the body is exposed to sustained pressure and shear, a pressure ulcer can develop in that location. Pressure ulcers are painful wounds that can develop quickly but tend to heal slowly.

In a hospital or care facility, caregivers adhere to specific protocols to prevent the occurrence of pressure ulcers. One important part in the prevention regimen is regular turning and re-positioning of the patient.

Various types of support mattresses exist on the market, which aim to prevent the formation of pressure ulcers. Such mattresses may comprise a gel, a foam or air to redistribute pressure under the body.

In order to assist patent re-positioning and to hold the patient in a desired protective position, a pressure redistribution pad may be utilized, either on its own, or in conjunction with the mattress.

One example of such a pressure redistribution pad is a fluidized positioner.

Fluidized positioners exist on the market, and typically comprise a fluidized medium. The fluidized medium preferably has no or limited shape memory such that the pad can conform to the skin of a patient in various positions.

The fluidized positioner may offload bony prominences on patients at risk of developing pressure ulcers. In use, the fluidized positioner may be arranged directly underneath a body part of a patient in a hospital bed. Alternatively, it may be used in conjunction with a mattress to angle a patient and hold the patient in a specific position for the purpose of pressure offloading.

A fluidized positioner may also be used for premature infants to support positioning of the infant's head and/or body. The fluidized positioner redistributes pressure over a greater surface area and can conform to the infant's head and body and create a “nest” or a cradle for the infant.

Existing fluidized positioners comprise an outer plastic shell which is filled with fluidized medium. The exterior plastic surface is moisture impermeable and not ideal for close contact with the skin of a patient. Existing fluidized positioners are typically single-patient use; i.e. after one positioner has been used for a specific patient and a specific care scenario, the positioner is discarded.

One challenge with existing fluidized positioner is that the plastic shell does not provide optimal comfort or microclimate when placed in close contact with a patient's skin. For example, when used against the fragile skin of a neonatal, the plastic shell may be experienced as uncomfortable. Furthermore, body liquids, such as sweat precipitated from a patient's skin will not be absorbed or transported away.

In some hospitals, the caregivers may place the positioner in a conventional pillowcase to address this issue. However, such pillowcases do not overcome the challenges mentioned hereinbefore. Furthermore, conventional pillowcases may impair the moldability of the fluidized positioner and may cause the positioner to slide with respect to the pillowcase and with respect to the patient's skin.

Another challenge with existing fluidized positioners is that when the positioner is used for offloading of a heavy body part, such as the back of a patient, the positioner may “bottom out”. Bottoming out means the fluidized medium of the moldable pad may flow towards the edges such that the area in contact with a heavy body part is left with a reduced amount of fluidized medium. This is not desired since the pressure-offloading may then be impaired.

To summarize, there is a need to provide an improved fluidized positioner which solves or at least alleviates the challenges mentioned hereinbefore.

### SUMMARY

In view of the above mentioned and other drawbacks of the prior art, it is an object of the present disclosure to provide improvements with respect to fluidized positioners when used for the purpose of re-positioning and/or for pressure offloading.

According to a first aspect, there is provided a moldable pad assembly for supporting a body part; the moldable pad assembly comprising a moldable pad, wherein the moldable pad comprises an outer shell enclosing a fluidized medium; the outer shell having a top surface facing the body part, and an opposing bottom surface, wherein the moldable pad assembly further comprises a cover detachably attached to the outer shell of the moldable pad, wherein the cover is arranged to enclose at least the top surface of the outer shell during use.

The cover is detachably attached to the outer shell; i.e. to the moldable pad, such that the entire top surface of the outer shell is enclosed by the cover. Hence, after the moldable pad has been used for a specific care scenario and for a specific patient, the cover may be removed and replaced with a new cover. This allows for the moldable pad to be used with more than one patient and in a variety of care scenarios.

In exemplary embodiments, the cover is defined by peripheral edges and comprises closure means adjacent the peripheral edges; the closure means being an elastic string or a drawstring, which allows the cover to adopt a hemispherical shape enclosing the top surface and at least a portion of the bottom surface of the outer shell of the moldable pad during use.

Accordingly, the cover forms an interior cavity for receiving the moldable pad and adopts a “shower cap” configuration. This configuration is associated with various advantages. First, the cover may easily be attached and detached from the moldable pad. For example, after a specific care scenario, the cover may be removed, and the outer shell of the moldable pad may be cleaned and disinfected such that the moldable pad may be used for another patient or another care scenario. Furthermore, the cover stays in place during use.

When the moldable pad assembly is utilized for patient re-positioning or offloading, the configuration of the moldable pad assembly prevents the moldable pad from “bottoming out”. The closure means and the hemispherical shape of the cover encloses the top surface and at least a portion of the bottom surface of the moldable pad during use, and thereby restricts the fluidized medium from flowing towards the edges of the moldable pad. Accordingly, this configuration secures that the fluidized medium of the moldable pad stays in place and provides proper offloading.

When the moldable pad assembly is used for neonatal infants, the bottoming out problem may not be as significant. Instead, with this intended use, it is important that the cover “molds with” the moldable pad and conforms to the molding and shape of the moldable pad without causing undesired wrinkles against the skin. Wrinkles may enhance the friction against the skin, and give rise to undesirable shear forces and chafing, which could give rise to pressure ulcers or skin damage. The closure means; i.e. the elastic string or the drawstring, secure that the cover is stretched out and forms a substantially wrinkle-free and skin-friendly surface arranged in contact with the skin of a patient; e.g. a baby.

In exemplary embodiments, the cover may comprise a breathable material

When the moldable pad is placed in direct contact with the skin of a patient, breathability is important to keep the patient comfortable and cool. This way, the microclimate is improved, and body fluids, such as sweat, or urine is more efficiently handled.

In exemplary embodiments, the cover may comprise a top layer and a bottom layer, and wherein at least one of the top and bottom layers is absorbent.

Preferably, the cover or at least one of the layers of the cover is absorbent.

This way, the liquid handling properties of the moldable pad are significantly improved. A breathable and absorbent cover improves the microclimate, which is important for pressure ulcer prevention.

Preferably, the moldable pad has no shape memory.

Hence, the moldable pad may easily adopt a specific shape with little force but retains its shape when the force is removed. This way, the moldable pad may be sculpted and may provide three-dimensional contouring to a body part during use. The pressure offloading effect is thereby improved. The moldable pad may be sculpted depending on the specific use of the pad, e.g. to maintain a specific position of a patient during turning and pressure offloading, or to provide a comfortable cradle for a neonatal infant.

In exemplary embodiments, the fluidized medium comprises a viscous fluid and a plurality of microparticles.

A viscous fluid is preferred to improve the moldability of the moldable pad.

The viscous fluid lubricates and coats the exterior surface of the microparticles and reduces the friction between the microparticles. A compact fluidized medium, which does not flow in the absence of a shear force, is thus accomplished.

The viscous fluid may be silicone oil or mineral oil.

In exemplary embodiments, the cover comprises at least one product identifying marking associated with the moldable pad.

To date, moldable pads, which may also be referred to as “fluidized positioners”, existing on the market come in a vast variety of sizes and in a variety of categories with different intended uses; e.g. pressure offloading of specific body parts (e.g. the back, the heel, the head etc.), turning and positioning, neonatal care (in heat incubators or in ambient atmosphere).

Accordingly, in various care scenarios, the selection of the correct moldable pad may become a time-consuming and complicated task. In other words, it may be difficult for the caregivers to understand what category of moldable pad to be used to achieve optimal results.

Also, as mentioned hereinbefore, the moldable pads are often placed in a pillowcase to prevent the outer shell of the moldable pad to be in direct contact with a patient. Such pillowcases typically come in one size (or at least a limited size range), which naturally does not fit with all moldable pads. This may result in a poorly fitted bed-pillow covering on the moldable pad.

The product identifying marking on the cover may support the caregivers and medical personnel in guiding them to easily identify and select the correct cover to be used with a specific moldable pad for a certain patient and a certain care scenario.

The product identifying marking may indicate a specific moldable pad category. The moldable pad category may be a category associated with the type of patient (neonatal or adult), the size of the moldable pad etc.

In exemplary embodiments, the at least one product identifying marking is formed by a print pattern, a weld pattern, a compressed pattern, an embossed pattern, a material deposition pattern, or combinations thereof.

Any pattern that allows the caregiver to visually recognize and follow the guidance provided by the at least one product identifying marking may be utilized.

Typically, the at least one product identifying marking is printed on the cover. Printed markings are easily recognizable.

The product identifying marking may also be a material deposition pattern. In this regard, the material deposition pattern may also allow for improved comfort, improved microclimate and/or improved breathability of the moldable pad assembly.

In exemplary embodiments, the product identifying marking may be a graphical element or a text element.

The product identifying marking may be a graphical element selected from a symbol, a figure, a pictorial representation, or an image.

The text element may e.g. indicate the size of the moldable pad to be used with the cover.

The graphical element may be indicative of a specific moldable pad category. The graphical element supports the caregivers with the correct selection of a cover for a particular moldable pad and also guides the caregiver to a correct use of the moldable pad assembly.

For example, the cover may comprise a first graphical element and a text element; the text element indicating the size of the moldable pad.

In exemplary embodiments, the cover may comprise a color-coded portion; the color-coded portion being indicative of a specific moldable pad category.

The color-coded portion improves and facilitates the selection of a specific moldable pad category. The color-coded portion may indicate a particular genre or category of moldable pads. Hence, the medical personnel are offered a clear and recognizable product identification, which significantly facilitates the selection of a specific type of moldable pad for a specific care scenario.

In exemplary embodiments, the outer shell of the moldable pad comprises at least one second product identifying marking correlating with the at least one product identifying marking of the cover.

Accordingly, the correct use of a cover with a specific moldable pad and in a certain care scenario is greatly facilitated.

According to another aspect, there is provided a kit comprising a moldable pad for supporting a body part, wherein the moldable pad comprises an outer shell enclosing a fluidized medium; the outer shell having a top surface facing the body part, and an opposing bottom surface, wherein the kit further comprises a cover configured to be detachably attached to the outer shell of the moldable pad and to enclose at least the top surface of the outer shell during use.

In exemplary embodiments, the cover comprises at least one product identifying marking associated with the moldable pad.

In exemplary embodiments, the kit may further comprise an instructional sheet; the instructional sheet comprising a plurality of product identifying markings corresponding to the at least one product identifying marking of the cover, wherein the plurality of product identifying markings of the instructional sheet indicate the correct use and/or application of the moldable pad and the cover.

Further features of, and advantages with, the present disclosure will become apparent when studying the appended claims and the following description. The skilled addressee realizes that different features of the present disclosure may be combined to create embodiments other than those described in the following, without departing from the scope of the present disclosure.

### BRIEF DESCRIPTION OF THE DRAWINGS

The various aspects of the present disclosure, including its particular features and advantages, will be readily understood from the following detailed description and the accompanying drawings, in which:

FIG. 1 is a cross-sectional view of a moldable pad assembly according to an exemplary embodiment of the present disclosure.

FIG. 2A illustrates a cover of the moldable pad assembly, as seen from the top of the cover, according to an exemplary embodiment of the present disclosure.

FIG. 2B illustrates a cover of the moldable pad assembly, as seen from the bottom of the cover, according to an exemplary embodiment of the present disclosure.

FIG. 3A illustrates the assembly of a cover and a moldable pad of the moldable pad assembly according to an exemplary embodiment of the present disclosure.

FIG. 3B illustrates a moldable pad assembly, as seen from the side, after the assembly in FIG. 3A.

FIGS. 4A-E illustrate a variety of covers comprising different types of product identifying markings.

FIG. 5 illustrates a neonatal infant positioned in a moldable pad assembly according to an exemplary embodiment of the present disclosure.

### DETAILED DESCRIPTION

The present invention will now be described more fully hereinafter with reference to the accompanying drawings, in which currently preferred embodiments of the present invention are shown. The present invention may, however, be embodied in many different forms and should not be construed as limited to the embodiments set forth herein; rather, these embodiments are provided for thoroughness and completeness, and fully convey the scope of the present invention to the skilled person.

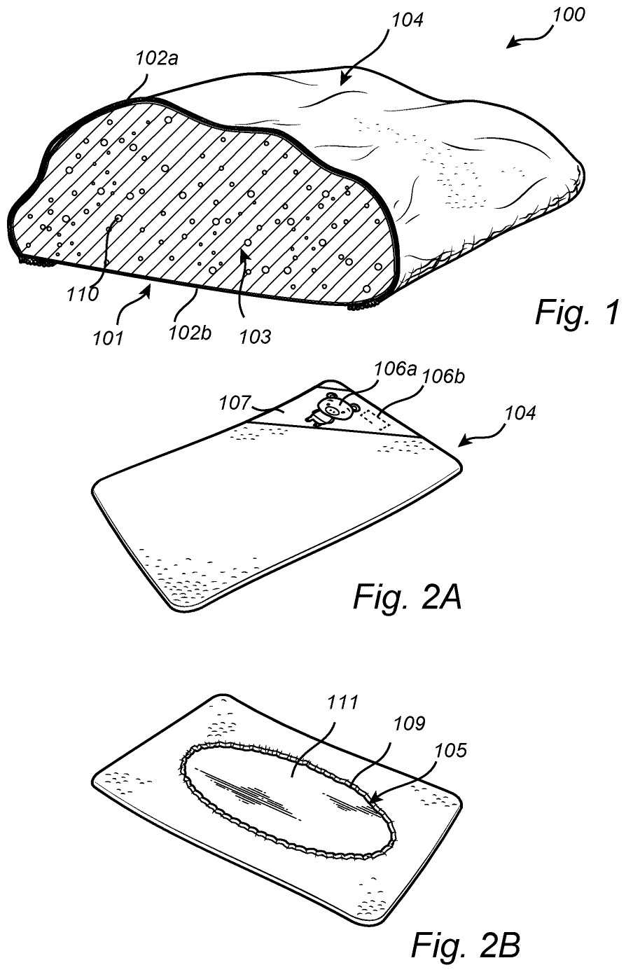

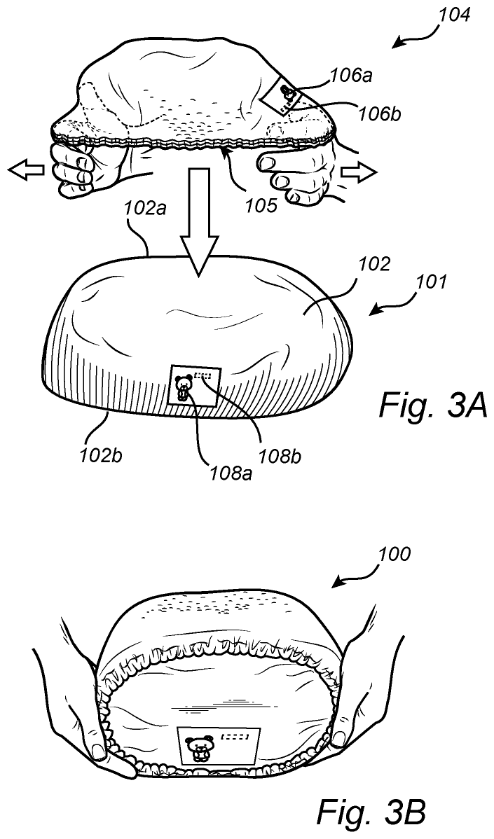

FIGS. 1 and 3A-B illustrate a moldable pad assembly 100 for supporting a body part; the moldable pad assembly 100 comprising a moldable pad 101, wherein the moldable pad 101 comprises an outer shell 102 enclosing a fluidized medium 103; the outer shell 102 having a top surface 102a facing the body part, and an opposing bottom surface 102b, characterized in that the moldable pad assembly 100 further comprises a cover 104 detachably attached to the moldable pad 101, wherein the cover 104 is arranged to enclose at least the top surface 102a of the moldable pad 101 during use.

As used herein, the term “moldable pad” means that the pad may be molded into any shape upon the application of a force. Preferably, the moldable pad has no shape memory. In other words, after the moldable pad has adopted a specific shape upon the application of a force, that shape is retained when the force is removed.

The outer shell 102 of the moldable pad may be any bladder or chamber in which the fluidized material may be enclosed. For example, the outer shell may be formed by two films or layers welded together along the peripheral edges of the films or layers.

The outer shell 102 has a top surface 102a and a bottom surface 102b. The top surface and the bottom surface may be defined between the welded peripheral edges of the films or layers forming the outer shell.

The outer shell 102 typically comprises a moisture and vapor impermeable material. The outer shell may comprise a plastic material such as a polymer-based material, e.g. polyurethane, polyethylene etc.

The thickness of the outer shell 102 may be in the range of from 0.05 to 0.5 mm, preferably in the range of from 0.08 to 0.3 mm.

This range is desired to secure that the moldability of the pad is maintained while simultaneously securing that the fluidized medium is prevented from leaking out from the moldable pad during use. If the thickness of the outer shell is too high, this may restrict the moldability of the pad. If the thickness is too low, the risk of rupture of the outer shell during use is enhanced.

Typically, the outer shell 102 is formed from two polymer-based films, e.g. polyurethane films, welded together.

As used herein, the term “fluidized medium” means a medium which flows under an applied shear force. The fluidized medium does not flow due to gravity. The fluidized medium is preferably shape retaining and may be pushed into a shape with very little force, but retains that shape when the force is removed.

The fluidized medium 103 comprises a viscous fluid, e.g. a viscous oil, e.g. a silicone oil or a mineral oil. The fluidized medium may further comprise microparticles 110 having an average diameter less than 500 μm, e.g. an average diameter of from 10 to 300 μm.

The viscous fluid lubricates and coats the exterior surface of the microparticles 110 and reduces the friction between the microparticles. A compact and firm medium, which does not flow in the absence of a shear force, is thus accomplished.

Preferably, the microparticles 110 are microspheres. The microspheres may be hollow phenolic, glass or plastic particles. Typically, the microspheres are hollow spherical particles with plastic walls.

The fluidized medium 103 may further comprise an additional lightweight material, such as foam beads. The foam beads may e.g. comprise polyethylene or polystyrene.

The moldable pad may e.g. be formed by filling an outer shell with a mixture of the viscous fluid and microspheres and subsequently removing gas, e.g. air by vacuum. The removal of gas may be varied and may affect the flow characteristics of the fluidized medium. For example, gas may be evacuated to achieve a subatmospheric pressure in the range of 5 to 500 mbar below ambient pressure.

A viscous fluid means a fluid having a viscosity in the range of from 100 to 600 cSt, preferably from 200 to 400 cSt at a temperature of 20° C.

The maximum thickness of the moldable pad may be in the range of from 10 to 250 mm, e.g from 20 to 200 mm. The thickness will vary depending on the use of the moldable pad. For example, a moldable pad intended to offload the back of an adult patient is typically thicker than a moldable pad intended to offload the head of a neonatal.

The moldable pad is not limited to a specific shape, but may be rectangular, square shaped or oval. Typically, the moldable pad is rectangular.

The size of the moldable pad may vary depending on the body part to be offloaded, the size and/or weight of the patient (adult or neonatal) etc.

The length of the moldable pad may be in the range of from 10 to 100 cm, e.g. from 20 to 80 cm. The width of the moldable pad may be in the range of from 10 to 80 cm, e.g. from 15 to 65 cm.

As best illustrated in FIGS. 3A and 3B, the cover 104 is arranged to enclose at least the top surface 102a of the outer shell 102 of the moldable pad 101 during use. Typically, the cover is arranged to enclose at least a portion of the bottom surface 102b of the outer shell 102.

The cover may be defined by peripheral edges 109 (see FIG. 2B) and comprises closure means 105 adjacent the peripheral edges 109; the closure means 105 being an elastic string or a drawstring, which allows the cover 104 to adopt a hemispherical shape (see FIG. 3A) enclosing the top surface 102a and at least a portion of the bottom surface 102b of the moldable pad 101 during use.

For example, the closure means may be an elastic string, such as an elastic thread, band or cord sewn into the cover adjacent the peripheral edges 109.

Alternatively, the elastic closure means may be a drawstring. A drawstring may be advantageous since it allows the caregiver the adjust the tightening of the cover. The ends of the drawstring may be tied to hold the drawstring in place. A tighter fit with the moldable pad may e.g. be useful when the moldable pad is used for the purpose of offloading a heavy body part of a patient.

The cover forms an interior cavity 111 for housing the moldable pad 101. A central portion of the bottom surface of the outer shell of the moldable pad is typically not covered by the cover 104.

The moldable pad assembly may be easily attached and detached from moldable pad. Furthermore, compared to a conventional pillowcase, the “shower cap” construction of the moldable pad assembly of the present disclosure allows the cover to conform to the molding and contouring of the moldable pad. It also prevents the moldable pad from bottoming out during use with heavy body parts.

The attachment between the cover 104 and the outer shell 102 of the moldable pad 101 is typically a non-adhesive attachment.

Preferably, the cover comprises a breathable material.

The present disclosure is not limited to a specific material, but any breathable, soft, and skin-friendly material is conceivable.

Preferably, the cover is also absorbent. This way, the liquid handling properties of the moldable pad assembly are significantly improved. A breathable and absorbent cover improves the microclimate, which is important for pressure ulcer prevention.

The cover may comprise a stretchable material. If the cover is too stiff, the moldability of the pad may be impaired. A stretchable material allows the cover to conform to any contoured shape adopted by the moldable pad.

The cover 104 may e.g. comprise a polyurethane foam or a nonwoven material. These materials are skin-friendly and breathable and improve the comfort to the skin of a patient.

A polyurethane foam is beneficial since it is capable of absorbing large amounts of fluids and also has a pressure relieving effect. The pressure relieving effect is beneficial to further prevent pressure ulcers from occurring. A polyurethane foam is also soft, conformable, and stretchable.

A nonwoven material has the ability to distribute fluid throughout the majority of the material such that the body liquid is evaporated across a larger surface area. The breathability of the cover (and the moldable pad) is thereby improved.

It is also conceivable that the cover comprises a plurality of layers.

For example, the cover may comprise various layers laminated or adhesively attached to each other. Each of such layer may have a liquid distribution or liquid acquisition effect and/or a comfort providing effect.

In exemplary embodiments, the cover may comprise a top layer and a bottom layer, and wherein at least one of the top and bottom layers is absorbent.

For example, the top layer may comprise a breathable material, such as a nonwoven material, and the bottom layer may comprise an absorbent material.

The absorbency may be enhanced in selected portions of the cover. Hence, the cover may comprise a top layer arranged to cover the top surface of the outer shell of the moldable pad. The cover may e.g. comprise an absorbent bottom layer, which only covers a portion of the first layer (and the moldable pad).

In embodiments where the cover comprises a top layer and a bottom layer, the bottom layer may be provided with a plurality of cuts or slits. The cuts or slits enhance the flexibility of the cover and allows the cover to conform to the shape adopted by the moldable pad.

In exemplary embodiments, at least a portion of the cover may be substantially transparent. This allows the caregiver to see the moldable pad through the cover. This may improve the visual appearance of the product and may emphasize the use of the moldable pad.

FIG. 2As and 2B illustrate a cover according to an exemplary embodiment.

As illustrated in FIG. 2A, the cover 104 may comprise at least one product identifying marking 106a-b associated with the moldable pad 101.

As used herein, the term “product identifying marking” means a marking indicating a particular category, size, property or an intended use associated with the moldable pad.

The at least one product identifying marking 106a-b may be formed by a print pattern, a weld pattern, a compressed pattern, an embossed pattern, a material deposition pattern, or combinations thereof.

In FIG. 2A, the product identifying markings 106a-b are formed by a print pattern. Printed markings are easily recognizable on the first release liner.

The at least one product identifying marking 106a-b may be a printed marking formed by a colored ink.

Any colored ink may be used as long as it remains permanently adhered to the cover. For example, a flexographic ink may be used. The ink may be water based or solvent based; i.e. the ink may comprise an organic solvent, such as an alcohol, ester etc. that can dissolve the pigment, resin and potentially other additives.

The product identifying markings 106a-b may be printed on the cover by any conventional printing technique known in the art, including, but not limited to a gravure printing, a flexographic printing, an offset printing, an ink jet printing and the like.

It is also conceivable that the product identifying markings are formed by a material deposition pattern. This may be beneficial since the material deposition pattern may provide additional functional benefits to the cover, e.g. improved breathability and/or liquid handling.

As illustrated in e.g. FIG. 2A, the cover 104 comprises at least one product identifying marking, wherein the at least one product identifying marking is a graphical element 106a and a text element 106b.

The graphical element 106a may be a symbol, a figure, a pictorial representation or an image.

In FIG. 2A, the first product identifying marking 106a is a pictorial representation of a pig. The second product identifying marking 106b is a text element indicating the size of the moldable pad to be used with the cover 104.

These covers are particularly aimed for use with neonatal infants.

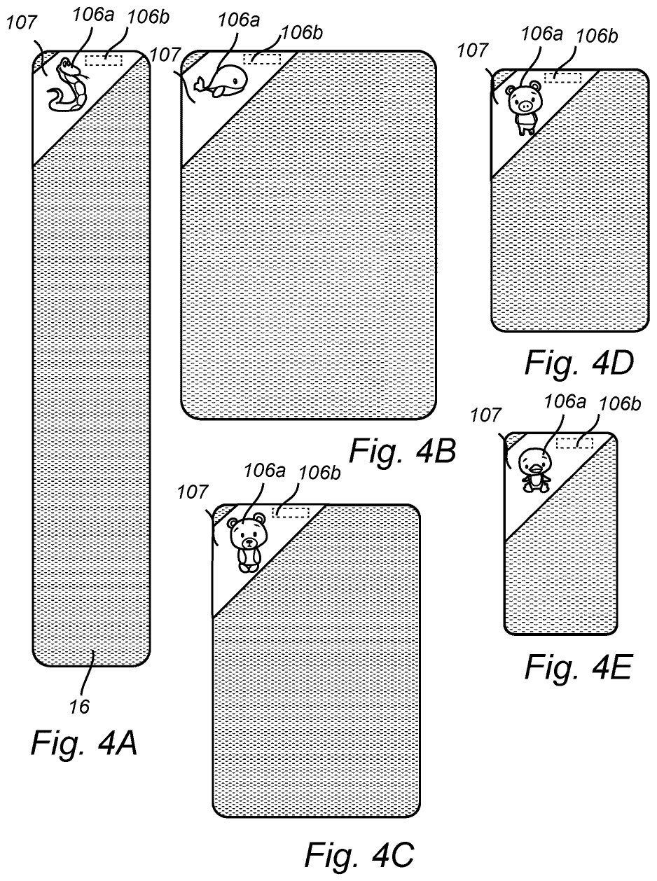

In FIGS. 4A-E additional illustrative covers are illustrated, each comprising its own unique product identifying elements. The graphical elements 106a in FIGS. 4A-E are pictorial representations of various animals, each pictorial representation being indicative of a particular size category. Each of the covers also comprises a text element 106b, typically a size indication of the moldable pad to be used with the cover 104.

The pictorial representations 106a-b may also yield a visually appealing impression. For example, when the moldable pad assembly of the present disclosure is used in neonatal care, the pictorial representations 106a-b may yield a more appealing appearance to an environment associated with discomfort and sterility.

Preferably, the cover comprises at least a first graphical element 106a and a text element 106b; the text element 106b indicating the size of the moldable pad 101.

In FIG. 2A, the product identifying markings is a figure of a pig.

FIGS. 4A-E illustrate other conceivable product identifying markings 106a. Each pictorial representation is indicative of a specific size category of the moldable pad.

To further improve the product selection and visual impression of the cover, the cover 104 may comprise a color-coded portion 107; the color-coded portion 107 being indicative of a specific moldable pad category.

The moldable pad category may be a category associated with the type of patient (neonatal or adult), the size of the moldable pad etc.

As illustrated in FIG. 2A, the product identifying markings 106a and 106b are arranged in the color-coded portion 107 of the cover. This yields a visually appealing and more cohesive impression.

The remaining portions of the cover may be white, transparent, or lighter in color than the color of the color-coded portion 107.

The color-coded portion preferably has a color that contrasts with the lighter color of the remaining portions of the cover. For example, the color-coded portion may be green, purple, pink, blue, green, red and any shades thereof.

As best illustrated in FIGS. 3A and 3B, the outer shell 102 of the moldable pad comprises at least one second product identifying marking 108a-b correlating with the at least one product identifying marking 106a-b of the cover 104.

The at least one second product identifying marking 108a-b may be arranged on the top surface 102a and/or on the bottom surface 102b of the outer shell 102 of the moldable pad 101.

This way, the caregivers and medical personnel are offered a direct and clear guidance as to the correct assembly of the moldable pad assembly, thereby securing proper use thereof.

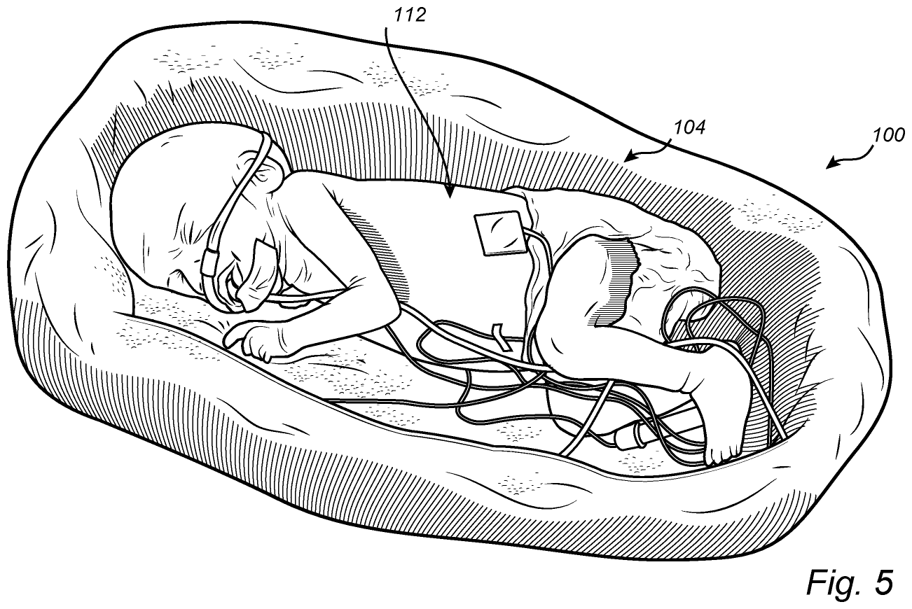

FIG. 5 illustrates a neonatal infant 112 positioned in a cradle formed by molding the moldable pad assembly 100. The cover 104 comprises a skin-friendly and breathable material which provides comfort to the neonatal infant resting thereon.

The closure means arranged to enclose the top surface and a portion of the bottom surface of the outer shell 101 secures that the cover 104 molds with and conforms to the shape of the moldable pad and prevents undesired wrinkles from forming against the skin of the infant. Furthermore, the closure means secure that the cover stays in place on the moldable pad during use.

According to another aspect, there is provided a kit comprising a moldable pad 101 for supporting a body part, wherein the moldable pad 101 comprises an outer shell 102 enclosing a fluidized medium 103; the outer shell 102 having a top surface 102a facing the body part, and an opposing bottom surface 102b, wherein the kit further comprises a cover 104 configured to be detachably attached to the moldable pad and to enclose at least the top surface 102a of the moldable pad during use.

The cover may comprise at least one product identifying marking 106a,b associated with the moldable pad.

The kit may further comprise an instructional sheet; the instructional sheet comprising a plurality of product identifying markings 106a-b corresponding to the at least one product identifying marking 106a-b of the cover 104, wherein the plurality of product identifying markings 106a-b of the instructional sheet indicate the correct use or application of the moldable pad and the cover 104.

The instructional sheet may e.g. be placed adjacent an incubator or a hospital bed such that the medical personnel is offered clear and direct guidance as to the correct use of the moldable pad assembly.

Terms, definitions and embodiments of all aspects of the present disclosure apply mutatis mutandis to the other aspects of the present disclosure.

Even though the present disclosure has been described with reference to specific exemplifying embodiments thereof, many different alterations, modifications and the like will become apparent for those skilled in the art.

Variations to the disclosed embodiments can be understood and effected by the skilled addressee in practicing the present disclosure, from a study of the drawings, the disclosure, and the appended claims. Furthermore, in the claims, the word “comprising” does not exclude other elements or steps, and the indefinite article “a” or “an” does not exclude a plurality.

1. A moldable pad assembly for supporting a body part; said moldable pad assembly comprising a moldable pad, wherein said moldable pad comprises an outer shell enclosing a fluidized medium; said outer shell having a top surface facing said body part, and an opposing bottom surface, characterized in that said moldable pad assembly further comprises a cover detachably attached to said outer shell of said moldable pad, wherein said cover is arranged to enclose at least said top surface of said outer shell during use.

2. The moldable pad assembly according to claim 1, wherein said cover is defined by peripheral edges and comprises closure means adjacent said peripheral edges; said closure means being an elastic string or a drawstring, which allows said cover to adopt a hemispherical shape enclosing said top surface and at least a portion of said bottom surface of said outer shell of said moldable pad during use.

3. The moldable pad assembly according to claim 1, wherein said cover comprises a breathable material.

4. The moldable pad assembly according to claim 1, wherein said cover comprises a top layer and a bottom layer, and wherein at least one of said top and bottom layers is absorbent.

5. The moldable pad assembly according to claim 1, wherein said moldable pad has no shape memory.

6. The moldable pad assembly according to claim 1, wherein said fluidized medium comprises a viscous fluid and a plurality of microparticles.

7. The moldable pad assembly according to claim 1, wherein said cover comprises at least one product identifying marking associated with said moldable pad.

8. The moldable pad assembly according claim 7, wherein said at least one product identifying marking is formed by a print pattern, a weld pattern, a compressed pattern, an embossed pattern, a material deposition pattern, or combinations thereof.

9. The moldable pad assembly according to claim 7, wherein said at least one product identifying marking is a graphical element and/or a text element.

10. The moldable pad assembly according to claim 9, wherein said at least one product identifying marking is a graphical element selected from a symbol, a figure, a pictorial representation, or an image.

11. The moldable pad assembly according to claim 1, wherein said cover comprises a color-coded portion; said color-coded portion being indicative of a specific moldable pad category.

12. The moldable pad assembly according to claim 7, wherein said outer shell of said moldable pad comprises at least one second product identifying marking correlating with said at least one product identifying marking of said cover.

13. A kit comprising a moldable pad for supporting a body part, wherein said moldable pad comprises an outer shell enclosing a fluidized medium; said outer shell having a top surface facing said body part, and an opposing bottom surface, wherein said kit further comprises a cover configured to be detachably attached to said outer shell of said moldable pad and to enclose at least said top surface of said outer shell during use.

14. The kit according to claim 13, wherein said cover comprises at least one product identifying marking associated with said moldable pad.

15. The kit according to claim 14, further comprising an instructional sheet; said instructional sheet comprising a plurality of product identifying markings corresponding to said at least one product identifying marking of said cover, wherein said plurality of product identifying markings of said instructional sheet indicate the correct use or application of said moldable pad and said cover.
